(19) United States
(12) Patent Application Publication
(10) Pub. No.: US 2026/0193917 A1
(43) Pub. Date: Jul. 9, 2026

(54) DOOR OPENER WITH FALLING DOOR DETECTION CAPABILITY

(71) Applicant: ASSA ABLOY Entrance Systems AB, Landskrona (SE)

(72) Inventors: David P. BRESSON, Pfafftown, NC (US); Davide BRAGGION, Milan (IT); Pasquale DI LORENZO, Milan (IT)

(21) Appl. No.: 19/014,784

(22) Filed: Jan. 9, 2025

(51) Int. Cl. E05D 13/00; E05F 15/43; E05F 15/681; E05F 15/77; E06B 3/48

(52) U.S. Cl. CPC E05D 13/003; E05F 15/681; E05F 15/77; E06B 3/485; E05F 2015/435; E05Y 2400/30; E05Y 2400/502; E05Y 2400/53; E05Y 2400/818; E05Y 2400/8515; E05Y 2800/252; E05Y 2900/106

(57) ABSTRACT

A method of detecting a faulted door condition with respect to a sectional door may include receiving current draw data associated with current draw of a motor of an opener of the sectional door measured while the motor transitions the sectional door between an open position and a closed position during a closing cycle or an opening cycle, receiving input voltage data for supplying the motor, determining, based on the current draw data or the input voltage data, whether a falling door condition exists, and initiating a door control action with respect to the sectional door in response to the falling door condition being determined to exist.

### TECHNICAL FIELD

Example embodiments generally relate to movable sectional doors, such as garage doors and, in particular, relate to an opener for such a sectional door that has the ability to detect, and in some cases also respond to, a falling door condition.

### BACKGROUND

Moveable sectional doors, such as garage doors, are commonly used to partition or enclose spaces. Just as commonly, an automated opening device is connected to the sectional doors in order to easily open or close the doors. As an example, a large portion of sectional doors for both residential and industrial applications employ an installed garage door opener (GDO) to automatically open and close the sectional doors. One solution for mounting and operating these GDOs is to mount the GDO from the ceiling proximate to the sectional door. For such ceiling mounted GDOs, a ceiling mounted linear force operator drags one of the connected sections of the sectional door through the guide rails the door rides in as the sectional door transitions between opened and closed positions.

A problem that can be encountered in the context above is that the sectional door may become unbalanced over time. When the sectional door is properly balanced, its weight is evenly distributed and tension management by the springs and other components of the system make the opening effort for the GDO relatively easy. However, when the sectional door becomes unbalanced, extra strain can be placed on the GDO and various other components, which can in some cases lead to component failure.

If the sectional door is unbalanced due to the torsion springs providing too little assistance to counterbalance the weight of the sectional door during closing, the sectional door may slip in the downward direction within the rails or tracks in which it normally moves. This slippage may, in an extreme case, result in the door essentially falling until contact with the ground, which would be highly undesirable. Detecting this situation when it occurs (or perhaps even before it may occur) may allow actions to be taken to avoid a worst case outcome. Similarly, if the supply voltage to the motor of the GDO is too low, there may not be sufficient power to properly hold the door during the closing cycle. Example embodiments are aimed at detecting, and in some cases also immediately responding, when a potential falling door situation is identified.

### BRIEF SUMMARY OF SOME EXAMPLES

In an example embodiment, a method of detecting a faulted door condition with respect to a sectional door may be provided. The method may include receiving current draw data associated with current draw of a motor of an opener of the sectional door measured while the motor transitions the sectional door between an open position and a closed position during a closing cycle or an opening, receiving input voltage data for supplying the motor, determining, based on the current draw data or the input voltage data, whether a falling door condition exists, and initiating a door control action with respect to the sectional door in response to the falling door condition being determined to exist.

In another example embodiment, a door opener for moving a sectional door via a roller assembly operably coupling the sectional door to a rail assembly to enable the sectional door to transition between an open state and a closed state may be provided. The door opener may include a controller, a motor operable under control of the controller to move the sectional door by carrying the sectional door in the rail assembly responsive to operation of the motor, and a fault detection module configured to detect a faulted door condition with respect to the sectional door. The detection of the faulted door condition may be accomplished by receiving current draw data associated with current draw of the motor measured while the motor transitions the sectional door between the open state and the closed state during a closing cycle or an opening cycle, receiving input voltage data for supplying the motor, determining, based on the current draw data or the input voltage data, whether a falling door condition exists, and initiating a door control action with respect to the sectional door in response to the falling door condition being determined to exist.

In still another example embodiment, a door operator system may be provided. The system may include a sectional door, an opener having a motor operable under control of a controller, and a fault detection module. The opener may be operably coupled to the sectional door to move the sectional door via a roller assembly operably coupling the sectional door to a rail assembly to enable the sectional door to transition between an open state and a closed state via the roller assembly carrying the sectional door in the rail assembly responsive to operation of the motor. The fault detection module may be configured to detect a faulted door condition with respect to the sectional door by receiving current draw data associated with current draw of the motor measured while the motor transitions the sectional door between the open state and the closed state during a closing cycle or an opening cycle, receiving input voltage data for supplying the motor, determining, based on the current draw data or the input voltage data, whether a falling door condition exists, and initiating a door control action with respect to the sectional door in response to the falling door condition being determined to exist.

### BRIEF DESCRIPTION OF THE SEVERAL VIEWS OF THE DRAWING(S)

Having thus described some example embodiments in general terms, reference will now be made to the accompanying drawings, which are not necessarily drawn to scale, and wherein:

FIG. 1 illustrates a perspective view of a door opener system in a ceiling mounted or trolley configuration in accordance with an example embodiment;

FIG. 2 illustrates a block diagram of a door opener system having a fault detection module located at the opener of the system in accordance with an example embodiment;

FIG. 3 illustrates a block diagram of the fault detection module in accordance with an example embodiment;

FIG. 4 illustrates a plot of current draw data to show phases of interest for balance determinations associated with detecting a falling door in accordance with an example embodiment;

FIG. 5 illustrates a plot of current draw data for both opening and closing cycles in accordance with an example embodiment;

FIG. 6 illustrates plots of current draw for opening and closing cycles with a significant mismatch according to an example embodiment;

FIG. 7 illustrates a fault detection algorithm for executing a method of identifying a falling door condition according to an example embodiment; and

FIG. 8 illustrates a user interface screen for notifying a user of the falling door condition in accordance with an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

As indicated above, an unbalanced sectional door can be identified via a number of different physical manifestations or noticeable indicia. For example, if the sectional door makes strange or loud noises, or moves unevenly or at a slant when opening or closing, an unbalanced condition may exist. Alternatively, if the sectional door moves unusually slow, or fails to move at all, an unbalanced condition may exist. Whereas the user could certainly wait to notice one of these conditions, the fact of the matter is that once those conditions are noticed, the potential for component damage has already likely been in existence for some time. The motor, spring, rollers, cable, etc., may be damaged and may fail, which may render the door inoperable for a period of time until potentially expensive repairs can be conducted. Moreover, as noted above, if the failure occurs during a closing cycle or an opening cycle, or if there is insufficient input power to the motor, a falling door situation may occur. Of note, if there is insufficient input power to lift the sectional door, the door may never be lifted, so the risk of the falling door situation occurring may be negligible. However, during a closing cycle, if a failure occurs (or has occurred) and there is insufficient input power to the motor, the motor may not be able to control the sectional door during descent and the falling door situation may occur (e.g., the sectional door may physically fall or drop rapidly to the floor/ground from a height above the floor/ground). Similarly, during either an opening or closing cycle, if a failure occurs (e.g., a cable or spring breaks), the motor may not have sufficient power to control the door during whatever remains of the opening/closing cycle and a falling door condition may exist. This could be seen by the motor suddenly drawing more current than normal in an effort to control movement of the sectional door.

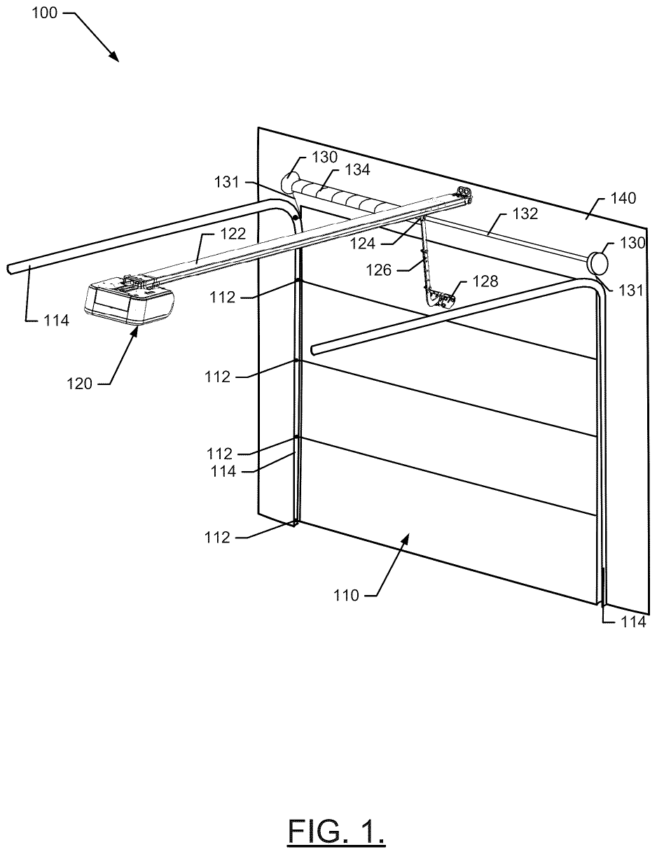

Accordingly, example embodiments aim to monitor input power to the motor and monitor current draw by the motor to identify situations where a falling door may occur. Moreover, in some cases, example embodiments may further initiate a response to a falling door situation automatically. More particularly, the increased friction or otherwise increased work the opener must perform when the sectional door is unbalanced may be expected to necessarily increase the current draw of the motor. Thus, by monitoring current draw over time, it may be possible to detect when the current draw is increasing over time or has reached specific thresholds that suggest that maintenance may be warranted to avoid a falling door. However, monitoring current draw and voltage supply in real time may also enable an immediate and perhaps mitigating response to be initiated such as, for example, reversing power to the motor during a closing cycle to attempt to hold or raise the door to mitigate the falling that would otherwise occur. Thus, for example, example embodiments may provide a “hold the door” function in the event that a falling door is actively in progress and detected. FIG. 1 illustrate a system in which example embodiments may be employed.

More particularly, FIG. 1 illustrates a garage door operator (GDO) system 100 of an example embodiment. In this regard, FIG. 1 shows the GDO system 100 in a trolley (or ceiling mounted) configuration, but it should be understood that example embodiments may also apply to situations in which the GDO system 100 is in a jackshaft configuration. In both cases, the GDO system 100 includes a sectional door 110, in which each section of the door has rollers 112 operably coupled to opposing lateral sides of the sections. The rollers 112 are typically rotatably operably coupled to the sectional door 110 via brackets that rotatably support a shaft of the rollers 112 and enable a wheel to extend into and ride within rails 114 disposed on opposing sides of the sectional door 110 as the sectional door 110 transitions between open and closed positions. The sectional door 110 of FIG. 1 is shown in the closed position, where the rollers 112 are in a vertical section of the rails 114. Thus, it can be appreciated that in the open position the rollers 112 are located in a horizontally extending portion of the rails 114, and the sectional door 110 is carried into parallel with the ground as opposed to its condition of being perpendicular to the ground in the closed position shown in FIG. 1. Each section of the sectional door 110 can pivot relative to any adjacent section at an intersection thereof in order to enable the sectional door 110 to traverse the bend that separates the horizontally extending portion of the rails 114 from the vertically extending portion of the rails 114.

FIG. 1 also illustrates a GDO unit referred to as an opener 120 or motorhead. The opener 120 of this example is shown in the trolley configuration in which a guide rail 122 may extend parallel to and approximately midway between the horizontally extending portion of the rails 114 on opposing lateral sides of the sectional door 110. The opener 120 may be mounted (e.g., from the ceiling) proximate to an end of the guide rail 122 to drive a trolley 124 along the guide rail 122 via a flexible member such as a belt, cable or chain. The belt, cable or chain may also be operably coupled (e.g., via the trolley 124) to a top portion of the sectional door 110 by an engaging arm 126 and engaging bracket 128 that is attached to the sectional door 110. As noted above, the trolley 124 may be manually released from the sectional door 110 to allow for manual repositioning of the sectional door 110.

In some cases, the sectional door 110 may also be supported by one or more instances of cables 131 that are alternately wound onto and off of one or more cable drums 130 disposed at or near opposing ends of a tube 132 (sometimes called a drive tube). The cables 131 may be attached to a bottom portion of the sectional door 110 to assist in carrying the weight of the sectional door 110. The tube 132 may further support a spring assembly 134 that facilitates, along with the cables 131, supporting the weight of the sectional door 110 during opening and closing operations of the sectional door 110 using the opener 120. The sectional door 110, when closed, may block an opening provided in a front wall 140 of the garage in which the GDO system 100 is installed. The opening may be left open when the sectional door 110 is raised onto the horizontally extending portions of the rails 114. As can be seen in FIG. 1, the guide rail 122 may be secured to the front wall 140 at a proximal end of the guide rail 122, and the opener 120 may be suspended from the ceiling of the garage at a distal end of the guide rail 122.

The sectional door 110 is, as noted above, often comprised of panels of aluminum, steel, fiberglass, plastic, or other relatively lightweight, but otherwise structurally rigid material of any suitable type. In some cases, one or more of the panels of the sectional door 110 may include or be comprised of a glass or film that may be transparent or translucent to allow natural light to pass therethrough and into the garage or other space to which the sectional door 110 provides access. The opener 120 draws power, typically from an alternating current (AC) mains power supply, which may be accessed by corded connection to a power supply outlet.

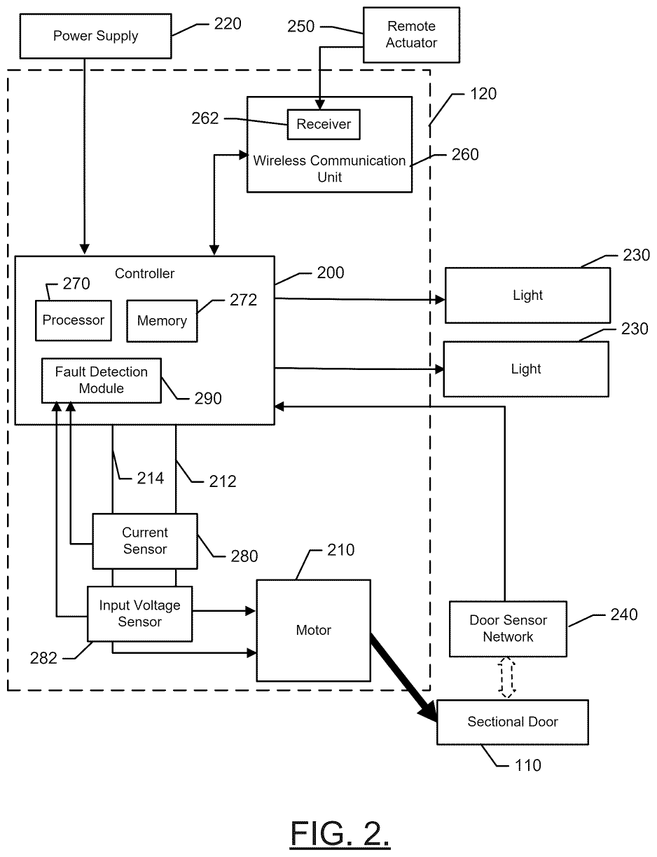

Turning to FIG. 2, a block diagram of various components of a GDO system of an example embodiment is shown. In particular, various internal components of the opener 120 of FIG. 1 are shown. In particular, the opener 120 may include a controller 200 and a motor 210. The motor 210 may operate under control of the controller 200, which may receive power from a power supply 220 (e.g., mains power), and may regulate the provision of power to the motor 210 to control both the operation of the motor 210 and the direction of the operation (e.g., closing or opening). In some cases, the controller 200 may provide separate power for forward (e.g., closing) and reverse (e.g., opening) directions of operation, and such power may be provided as a forward power connection 212 (for forward direction motor windings) and a reverse power connection 214 (for reverse direction motor windings). The controller 200 may also selectively provide power to a light 230 whenever the motor 210 operates (and for some period thereafter, or when otherwise turned on via the controller 200).

In an example embodiment, a door sensor network 240 may be disposed on or proximate to the sectional door 110 to monitor aspects of the movement of the sectional door 110 and/or its environment. The door sensor network 240 may include motion, speed, force and other sensors associated with movement of the sectional door 110 including, for example, limit switches that determine respective limits for motion of the sectional door 110 in both the opening and closing directions. Moreover, the door sensor network 240 may also include an obstruction sensor, which may detect when an object is between the sectional door 110 and the ground beneath the sectional door 110 to ensure that the sectional door 110 does not close on the object. In some cases, the obstruction sensor may include an infrared or other beam emitter, and a corresponding beam receiver that provides an input to the controller 200 to indicate that the beam emitted by the beam emitter is not being received at the beam receiver (e.g. due to the object, or misalignment of the emitter and receiver). When the controller 200 receives the input from the obstruction sensor, the controller 200 stops provision of power to the motor 210 to stop movement of the motor 210. Similarly, when the limit switches are triggered, the controller 200 is informed and stops movement of the motor 210, which in most cases simply means stopping the provision of power via both the forward and reverse power connections 212 and 214.

In an example embodiment, the controller 200 may be operable responsive to input from a mobile or fixed remote actuator 250 (often simply called a “remote”). In some cases, the remote actuator 250 may be directly or hard wired to the controller 200 and may, for example, be a button, panel or display located on a wall that is convenient for the user to access for operation of the opener 120 inside the garage or other space being enclosed via the sectional door 110. However, particularly for the mobile instances of the remote actuator 250, a wireless communication unit 260 may be included in the opener 120 to receive wireless transmissions from the remote actuator 250 to trigger operation of the controller 200 and consequently also the motor 210. The wireless communication unit 260 may, in some cases, include a receiver 262 that is capable of receiving transmissions from the remote actuator 250 for triggering operation of the controller 200.

The controller 200 may, in some cases, include processing circuitry that is configured to control the operation of the controller 200. In this regard, for example, the processing circuitry may include a processor 270 and memory 272. The memory 272 may store data, applications (e.g., for execution by the processor 270) or any other suitable information for local or remote usage consistent with the descriptions provided herein. In some cases, the processing circuitry may be part of a printed circuit board (PCB), application specific integrated circuit (ASIC) or other integrated circuit (IC) chip, board or the like. The processing circuitry may therefore, depending on its configuration (e.g., via hardware, firmware and/or software) enable the controller 200 to execute coordinated control over the motor 210 and various other accessories of the GDO system including, potentially, an ability to detect a falling door condition, or detect situations in which a falling door condition is a credible threat.

In order to incorporate the controller 200 into falling door condition determinations, the controller 200 may be operably coupled to one or more additional sensors that specifically monitors a parameter that changes in such a way as to indicate that a falling door condition exits, or could exist. As noted above, current draw by the motor 210 may be one such parameter, and input voltage to the motor 210 may be another. Thus, in an example embodiment, the opener 120 may further include a current sensor 280 that may monitor current drawn by the motor 210, and an input voltage sensor 282 to monitor input voltage to the motor 210. In some examples, the current sensor 280 and/or the input voltage sensor 282 may passively monitor both the forward and reverse power connections 212 and 214 by inductively measuring magnetic fluctuations in the forward and reverse power connections 212 and 214, and inferring current or voltage values based on the magnetic fluctuations. However, in other examples, the current sensor 280 and/or the input voltage sensor 282 may be wired into the circuit of the forward and reverse power connections 212 and 214 to measure current draw and input voltage. Any other suitable options for operable coupling of the current sensor 280 and/or the input voltage sensor 282 to the motor 210 in such a way that permits measurement of current draw and input voltage thereby are also possible. The current sensor 280 and the input voltage sensor 282 may, in some cases, provide current draw data and input voltage data, respectively, measured during a door operation cycle (e.g., opening or closing) to the controller 200, and the controller 200 may store the current draw data and/or input voltage data in the memory 272. However, as will be discussed above, some actions may also be taken in real time by example embodiments, so storage of data is not necessarily practiced in all cases, and may be omitted entirely in some.

The current measurements made by the current sensor 280 (i.e., the current draw data) and the input voltage data obtained by the input voltage sensor 282 may be provided (directly or indirectly) to a fault detection module 290. The fault detection module 290 may be configured to monitor the current draw by the motor 210 and the voltage supply to the motor 210 before and during operation of the motor 210 in order to determine whether any condition that may cause a falling door condition is present, and (during operation) whether a falling door condition is currently present. In some cases, this may include detecting when an under voltage condition exists on the supply side or whether an unbalanced condition exists. In some embodiments, the fault detection module 290 may be instantiated as an application stored in the memory 272 and executable by the processor 270. However, in other cases, the fault detection module 290 may have its own processing circuitry and, in still other embodiments, the fault detection module 290 may be located separately from the controller 200. In any case, the current draw data and/or input voltage to the motor 210 may be processed by the fault detection module 290 as described herein to determine whether the falling door condition exists. In response to determining that the falling door condition exists, the opener 120 (or the fault detection module 290) may provide an alarm or other indication (visual, audible, or electronic message) to the user to indicate as much. Thus, for example, the controller 200 may cause the light 230 to flash with a given pattern that is associated with indicating that the sectional door 110 is experiencing (or may experience) the falling door condition. However, a display at the controller 200 (or the fault detection module 290) could alternatively indicate the condition as well. The alarm or notification may be one example of a door control action that the fault detection module 290 may initiate in response to any determination of the falling door condition. Other actions may alternatively be employed as the door control action including, for example, reversing power on the motor 210 during a closing cycle (e.g., therefore applying power in the opening direction instead of the closing direction).

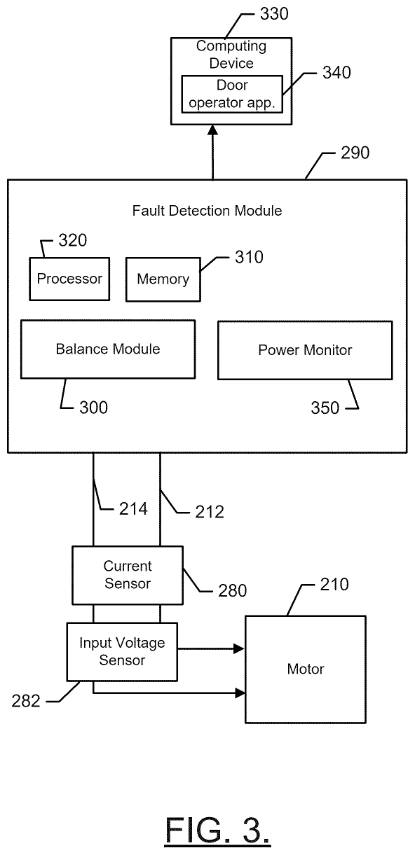

Before discussing how the fault detection module 290 identifies when the falling door condition exists, a basic structure for implementation of the fault detection module 290 will be discussed in reference to FIG. 3. In this regard, FIG. 3 illustrates an example in which the current draw data is provided from the current sensor 280 directly to a balance module 300. The balance module 300 may use the current draw data to determine whether an unbalanced condition exists and, more particularly, whether a falling door condition exists. The unbalanced condition may exist when the current draw data indicates an unusual (as compared to normal) amount of current is being drawn by the motor 210. In some cases, the unbalanced condition may correlate directly to a determination that the falling door condition exists. In other words, if the unbalanced condition exists, then the falling door condition may also exist. However, in some cases, the falling door condition may exist only when the unbalanced condition (although in existence) reaches a particular level of imbalance that either indicates an actively falling door or the potential for a falling door. Thus, the falling door condition may be determined to exist based on similar factors and parameters that can otherwise be used to detect imbalance. From the standpoint of definition, the falling door condition may be considered to be a situation in which the motor 210 is not capable of preventing the sectional door 110 from falling, or has a significant risk of being incapable of preventing the sectional door 110 from falling, when a significant portion of the sectional door 110 is in the vertical section of the rails 114. It can therefore be assumed that detecting the falling door condition either before operation of the motor 210, or when the sectional door 110 remains primarily supported in the horizontal section of the rails 114 may all complete avoidance of an active falling of the sectional door 110. Whereas, if the sectional door 110 happens to be primarily supported in the vertical section of the rails 114 when the falling door condition is detected, action may be taken to try to mitigate the situation or risk by applying all available power in the opening direction to either move the sectional door 110 back to being primarily supported in the horizontal section of the rails 114 or at least mitigating the chances of a fall by applying force in the opposite direction.

The balance module 300 may, in some cases, be instantiated in instructions stored in memory 310 of the fault detection module 290 (which may be the same as memory 272, or may be functionally and/or structurally similar to the memory 272). The instructions may be executed by a processor 320, which may be the same as processor 270, or may be functionally and/or structurally similar to the processor 270. The processing circuitry used to perform the processing of the balance module 300 may therefore include a processor and memory that are located at the opener 120. If an imbalance situation (or falling door condition) is detected, an alert, message or alarm may then be provided at the opener 120 or may be communicated via a message to a computing device 330 of the user (e.g., the user's home computer, tablet or smart phone) to indicate the condition. Moreover, a door operator application 340 on the computing device 330 may provide options for interacting with the message including making a service call to maintenance personnel. The message may be sent, for example, via 5G, LTE, WiFi, Bluetooth©, or other long or short range wireless communication protocols.

The fault detection module 290 may also, in some cases, include a power monitor 350 that may monitor input power to the windings (opening or closing) of the motor 210. In this regard, for example, the input voltage sensor 282 may provide input voltage measurements directly to the power monitor 350 to enable the power monitor 350 to determine if the input power is so low that it may impact the ability of the motor 210 to carry the weight of the sectional door 110 in transition between the open state and the closed state. For example, if the power supply is low for any reason, there may not be sufficient power for the motor 210 to operate normally, and the sectional door 110 (particularly if imbalanced) may end up falling or being at a higher risk of falling. Thus, for example, the power monitor 350 may compare the voltage measured by the input voltage sensor 282 to a threshold voltage value that defines the minimum input voltage that is sufficient to ensure that the motor 210 has full capability (or nearly so) to lift and/or hold the sectional door 110. The minimum input voltage may be a percentage of the average of a predetermined number of earlier cycles of the motor 210, or any other selected (e.g., fixed) value that may be determined by the manufacturer. If the voltage measured by the input voltage sensor 282 is below the threshold voltage value, the falling door condition may be determined. Notably, the voltage measurement may be made before or during operation of the motor 210. Thus, for example, if the input power is low, the falling door condition may be determined (and the user may be notified) before the sectional door 110 is even attempted to be moved.

In relation to determining the unbalanced condition (which may further determine the falling door condition) itself, the balance module 300 may monitor and/or process the current draw data. The processing may include comparing received current draw data (i.e., the current draw data most recently provided to the balance module 300) to reference current draw data. The reference current draw data may be provided for a class of openers 120 initially, or may be built up over time by, for example, averaging the current draw data previously received to define a running and continuously or periodically updated average of reference current draw data. Regardless of how measured or determined, if the reference current draw data is different from the received current draw data by greater than a threshold amount, then an unbalanced condition may be detected. As noted above, the unbalanced condition may further indicate the falling door condition in some cases, although a different threshold may be used for the falling door condition than the unbalanced condition. For example, a lower threshold may indicate the unbalanced condition, and a higher threshold (i.e., more imbalance) may indicate the falling door condition. In either case, the balance module 300 (or more generally the fault detection module 290) may compare the received and reference current draw data and determine a difference therebetween in order to determine whether the unbalanced condition and/or the falling door condition exists.

Although the general concept of this comparison may be relatively straightforward, it should be appreciated that given the number of cycles of opening and closing that may occur in a given period of time, the amount of data that may ultimately be generated may become cumbersome to process and/or store. Moreover, it may also be the case that it is not necessary to run comparisons over the full scope of measured data, but instead comparisons may be strategically limited to particular portions of the measured data that are most likely to be informative in relation to the condition being detected. Accordingly, data may in some cases only be processed for particular phases or even event stages within the particular phases. The focus on a smaller section of data may further mean that in some cases, less data needs to be recorded and stored, communicated and processed.

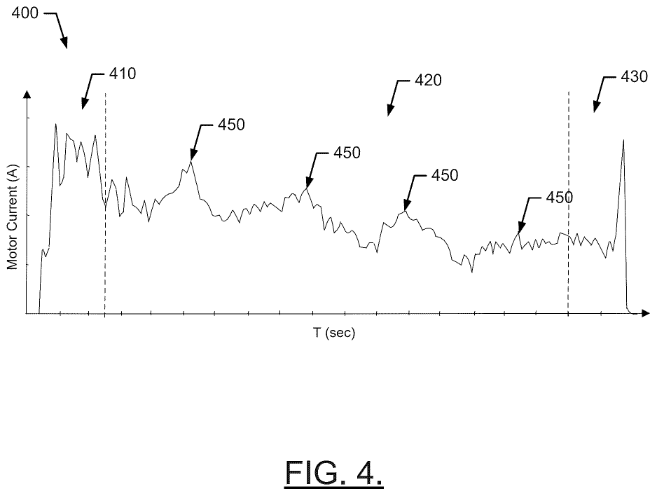

FIG. 4 illustrates an example plot 400 of received current draw data according to an example embodiment. The plot 400 shows current draw versus time for an opening cycle of the sectional door 110. The plot 400 is broken into three phases including a kickoff phase 410, a running phase 420 and a slowdown phase 430. For the opening cycle, the kickoff phase 410 typically involves a large current draw since the full weight of the sectional door 110 is being lifted off the floor. Since the movement of the sectional door 110 in the kickoff phase 410 is largely happening in a vertical section of the rails 114, there may not be much change in the current draw from one cycle to the next, even if measured over a long period of time. Thus, the kickoff phase 410 may not be a good phase to use for detecting imbalance. Likewise, in the slowdown phase 430 of the opening cycle, the sectional door 110 is mostly lying in a horizontal plane getting closer to the opener 120 and slowing down as the limit of motion is approached. Thus, the weight of the sectional door 110 is almost all being borne by the horizontal sections of the rails 114 with little change either in one cycle or across different cycles.

However, during the running phase 420, each section of the sectional door 110 takes its turn transitioning through the portion of the rails 114 that bends from the vertical section thereof to the horizontal section thereof. These transitions occur when the hinges between sections change between the horizontal to the vertical sections, and there tends to be a small surge in current draw to complete the transition event. Each of these transition events (i.e., four of them for a four panel door) is its own even stage that could be considered to be a stage of interest 450, and current tends to reach a noticeable peak during the stages of interest 450. Accordingly, for the purposes of maximizing accuracy with the storage, communication and processing of as little data as possible, in some cases, the fault detection module 290 (or balance module 300) may perform the detection algorithm on only data corresponding to the running phase 420, and may further focus on one or more of the event stages associated with each panel transitioning from horizontal to vertical sections of the rails 114. Thus, for example, only peak values may be stored, compared, or otherwise used for the detection algorithm in some cases. Normal ranges of peak values for opening and closing cycles, and sometimes specifically for each hinge set and panel transition, may therefore be stored to determine when performance falls outside normal ranges.

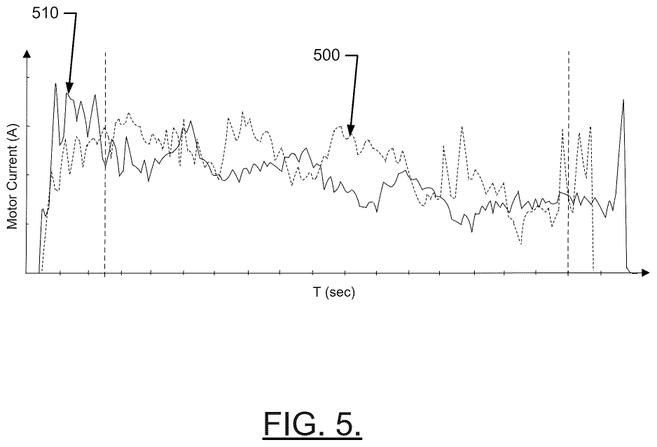

Other strategies for reducing storage requirements or simplifying calculations may include averaging values at intervals. In this regard, for example, the memory 310 may have limited storage capacity. Thus, rather than storing data associated with each and every opening or closing cycle, the memory 310 may have a limited or circular buffer and the processor 320 may average all or some of the data received over a given period of time to store only the average values in the memory 310. FIG. 5 illustrates an average opening cycle plot 500 and an average closing cycle plot 510 to illustrate the averaging concept. Comparisons may be made with respect to the average values of reference and/or received current draw data. Alternatively or additionally, the memory 310 may be selective in its storage strategy under direction from the processor 320. In this regard, for example, the memory 310 may store every third cycle, or any other suitable interval among the cycles. Opening and closing cycles may also be distinguished from each other, and compared to reference data that is specific to the same type of cycle.

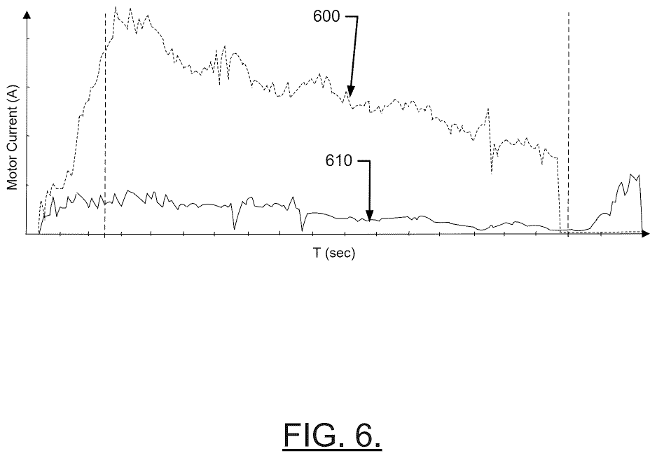

Referring to FIG. 5, it can be appreciated that the value of motor current for a closing cycle or an opening cycle may tend to be relatively close to each other in value for a balanced door. Thus, rather than performing any kind of averaging or more complicated processing, the memory 310 may simply store the last cycle (i.e., the last opening cycle for a closing cycle or vice versa). Meanwhile, if the door is imbalanced (e.g., over-sprung, under-sprung, broken spring, broken cable, excessive friction of drum/roller or the like, etc.), the cycles may instead show a large imbalance therebetween in relation to the current draw data. In the example of FIG. 6, the open cycle plot 600 is substantially higher in current draw than the close cycle plot 610. Thus, the plot of FIG. 6 clearly shows an imbalance. Therefore, by simply comparing the last open cycle to a current close cycle (or vice versa), an imbalance may easily be determined in some cases. Moreover, if the imbalance is of sufficient magnitude, the processor 320 may determine the imbalance to be a falling door condition. In this regard, as noted above, a first threshold may indicate imbalance and a second and larger threshold may indicate the falling door condition.

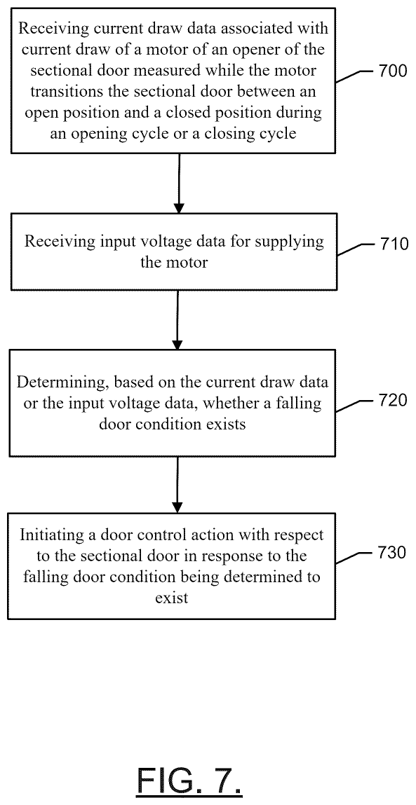

FIG. 7 is a block diagram of a falling door detection algorithm according to an example embodiment. In this regard, the falling detection algorithm may include receiving current draw data associated with current draw of a motor of an opener of the sectional door measured while the motor transitions the sectional door between an open position and a closed position during an opening cycle or a closing cycle at operation 700, receiving input voltage data for supplying the motor at operation 710, determining, based on the current draw data or the input voltage data, whether a falling door condition exists at operation 720, and initiating a door control action with respect to the sectional door in response to the falling door condition being determined to exist at operation 730 as an optional operation. In such cases, initiating the door control action may include providing a notification or sending the message noted above, or some other notification, to indicate the falling door condition to the user. Alternatively or additionally, the door control action may include applying power to the motor 210 in the opening direction to attempt to either move the sectional door 110 to the open position, or provide additional force to hold the sectional door 110 against gravity and any potential fall. The operations above may be modified in some cases, as discussed below in relation to the system components that execute the operations.

In some cases specific conditions may be further diagnosed based on comparing the shape of the curvature of the received current draw data, the magnitude of the peaks, or other aspects of the data to sample defect patterns that may be included in the reference current draw data. For example, the sample defect patterns may include cases for excessive spring wear, over-sprung conditions, hinge faults, rollers that need lubrication, and other conditions. Thus, for example, if the threshold difference value is exceeded, the fault detection module 290 of some examples may further engage in analysis to attempt to determine the nature of the fault that exists. Moreover, the fault detection module 290 of some embodiments may include libraries of historical data to enable spring wear calculations and modeling to be performed so that, for example, estimates of time remaining before spring replacement is likely to be needed can be made. In this regard, the balance module may engage in predictive modeling that enables percentage wear estimates to be made for various components of the sectional door 110 or the opener 120. Thus, instead of merely estimating life remaining for components based on number of cycles, the actual performance characteristics of the motor 210 may be studied to make determinations that are specific to the system in operation.

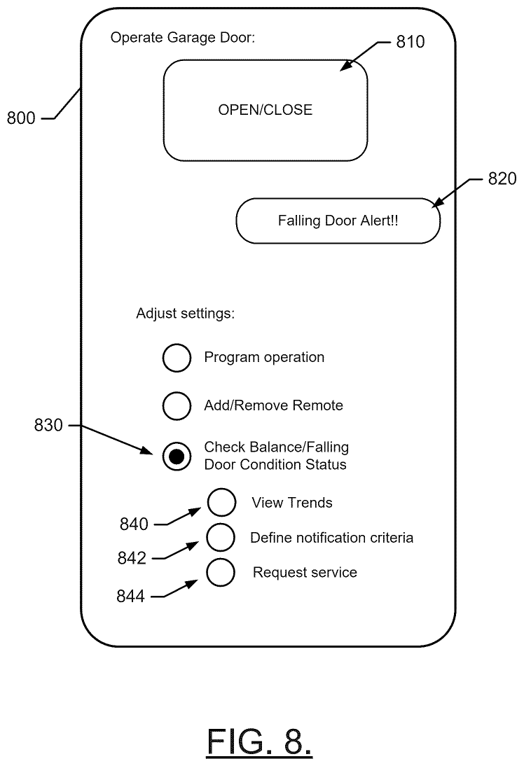

As noted above, when the unbalanced condition or the falling door condition is determined to exist, various means of notifying the user may be employed. One such means may be to provide a notification to the user on a computer or smart phone application via which various aspects of the operation of the opener 120 or the system in general may be managed. FIG. 8 illustrates one example of an interface screen 800 that may be used as part of a control console or web page for a remote computer/application. Of note, although the interface screen 800 of FIG. 8 shows an open/close button 810 on the same screen or page as a notification 820 and various other options for adjusting settings for the system, these separate functions may alternatively be provided on separate pages or screens.

In response to receipt of the notification 820, the user may check system settings, which may include an option to check balance status 830 (among other control options). When the check balance status 830 option is selected, various other options may be presented including, for example, the option to review trends 840, define notification criteria 842 or request a service call 844. The service call request, or perhaps another separate option may, in some cases, cause the data to be provided to the service technician or maintenance facility. The user may also or alternatively have a setting that provides a continuous reporting of current draw data to the service technician or maintenance facility and such data may be stored locally for analysis and building of the predictive models noted above. Other options and interactions may also be possible in other example embodiments.

Accordingly, some example embodiments may provide a door opener for opening a sectional door via a roller assembly operably coupling the sectional door to a rail assembly to enable the sectional door to transition between an open state and a closed state. The door opener may include a controller, a motor operable under control of the controller to move the sectional door by carrying the sectional door in the rail assembly responsive to operation of the motor, and a fault detection module configured to detect a faulted door condition with respect to the sectional door. The detection of the faulted door condition may be accomplished by receiving current draw data associated with current draw of the motor measured while the motor transitions the sectional door between an open position and a closed position during an opening cycle or a closing cycle, receiving input voltage data for supplying the motor, determining, based on the current draw data or the input voltage data, whether a falling door condition exists, and initiating a door control action with respect to the sectional door in response to the falling door condition being determined to exist.

The door opener and/or a system including the same, or components thereof described above may be augmented or modified by altering individual features mentioned above or adding optional features. The augmentations or modifications, or any optional features, may be combined in any combination including any of all of the features listed below. In this regard, for example, determining whether the falling door condition exists may include comparing the received current draw data to reference current draw data during the closing cycle to determine a current difference between the received current draw data and the reference current draw data, and determining the sectional door to be in the falling door condition responsive to the current difference being larger than a threshold current difference value. In this context, the reference current draw may include an opening cycle current draw, an average current draw value of a plurality of earlier closing cycles, or a maximum permissible peak current value. In an example embodiment, determining whether the falling door condition exists may include comparing the input voltage data to a reference input voltage prior to or during the opening or closing cycle to determine a voltage difference between the input voltage data and the reference input voltage data, and determining the sectional door to be in the falling door condition responsive to the voltage difference being larger than a threshold voltage difference value. In some cases, initiating the door control action may include applying an arresting current to the motor to drive the motor in an opening direction, or providing a notification locally at the opener regarding the falling door condition or providing a notification to an operator via wireless connectivity to a user device remotely located from the opener regarding the falling door condition.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

What is claimed:

1. A method of detecting a faulted door condition with respect to a sectional door, the method comprising:
receiving current draw data associated with current draw of a motor of an opener of the sectional door measured while the motor transitions the sectional door between an open position and a closed position during an opening cycle or a closing cycle;
receiving input voltage data for supplying the motor;
determining, based on the current draw data or the input voltage data, whether a falling door condition exists; and
initiating a door control action with respect to the sectional door in response to the falling door condition being determined to exist.

2. The method of claim 1, wherein determining whether the falling door condition exists comprises:
comparing the received current draw data to a reference current draw data during the opening cycle or during the closing cycle to determine a current difference between the received current draw data and the reference current draw data; and
determining the sectional door to be in the falling door condition responsive to the current difference being larger than a threshold current difference value.

3. The method of claim 2, wherein, in response to determining whether the falling door condition exists during a closing cycle, the reference current draw comprises an opening cycle current draw.

4. The method of claim 2, wherein the reference current draw comprises an average current draw value of a plurality of earlier opening cycles or closing cycles.

5. The method of claim 2, wherein the reference current draw comprises a maximum permissible peak current value.

6. The method of claim 1, wherein determining whether the falling door condition exists comprises:
comparing the input voltage data to a reference input voltage during the opening or closing cycle to determine a voltage difference between the input voltage data and the reference input voltage data; and
determining the sectional door to be in the falling door condition responsive to the voltage difference being larger than a threshold voltage difference value.

7. The method of claim 1, wherein determining whether the falling door condition exists comprises:
comparing the input voltage data to a reference input voltage prior to the opening or closing cycle to determine a voltage difference between the input voltage data and the reference input voltage data; and
determining the sectional door to be in the falling door condition responsive to the voltage difference being larger than a threshold voltage difference value.

8. The method of claim 1, wherein initiating a door control action comprises applying an arresting current to the motor to drive the motor in an opening direction.

9. The method of claim 1, wherein initiating a door control action comprises providing a notification locally at the opener regarding the falling door condition.

10. The method of claim 1, wherein initiating a door control action comprises providing a notification to an operator via wireless connectivity to a user device remotely located from the opener regarding the falling door condition.

11. A door opener for opening a sectional door via a roller assembly operably coupling the sectional door to a rail assembly to enable the sectional door to transition between an open state and a closed state, the door opener comprising:
a controller;
a motor operable under control of the controller to move the sectional door by carrying the sectional door in the rail assembly responsive to operation of the motor; and
a fault detection module configured to detect a faulted door condition with respect to the sectional door by:
receiving current draw data associated with current draw of the motor measured while the motor transitions the sectional door between an open position and a closed position during an opening cycle or a closing cycle;
receiving input voltage data for supplying the motor;
determining, based on the current draw data or the input voltage data, whether a falling door condition exists; and
initiating a door control action with respect to the sectional door in response to the falling door condition being determined to exist.

12. The door opener of claim 11, wherein determining whether the falling door condition exists comprises:
comparing the received current draw data to reference current draw data during the opening or closing cycle to determine a current difference between the received current draw data and the reference current draw data; and
determining the sectional door to be in the falling door condition responsive to the current difference being larger than a threshold current difference value.

13. The door opener of claim 12, wherein, in response to determining whether the falling door condition exists during a closing cycle, the reference current draw comprises an opening cycle current draw.

14. The door opener of claim 12, wherein the reference current draw comprises an average current draw value of a plurality of earlier closing cycles.

15. The door opener of claim 12, wherein the reference current draw comprises a maximum permissible peak current value.

16. The door opener of claim 11, wherein determining whether the falling door condition exists comprises:
comparing the input voltage data to a reference input voltage during the opening cycle or the closing cycle to determine a voltage difference between the input voltage data and the reference input voltage data; and
determining the sectional door to be in the falling door condition responsive to the voltage difference being larger than a threshold voltage difference value.

17. The door opener of claim 11, wherein determining whether the falling door condition exists comprises:
comparing the input voltage data to a reference input voltage prior to the opening cycle or the closing cycle to determine a voltage difference between the input voltage data and the reference input voltage data; and
determining the sectional door to be in the falling door condition responsive to the voltage difference being larger than a threshold voltage difference value.

18. The door opener of claim 11, wherein initiating a door control action comprises applying an arresting current to the motor to drive the motor in an opening direction.

19. The door opener of claim 11, wherein initiating a door control action comprises providing a notification locally at the opener regarding the falling door condition or providing a notification to an operator via wireless connectivity to a user device remotely located from the opener regarding the falling door condition.

20. A door operator system comprising:
a sectional door;
an opener having a motor operable under control of a controller, the opener being operably coupled to the sectional door to move the sectional door via a roller assembly operably coupling the sectional door to a rail assembly to enable the sectional door to transition between an open state and a closed state via the roller assembly carrying the sectional door in the rail assembly responsive to operation of the motor;
a fault detection module configured to detect a faulted door condition with respect to the sectional door by:
receiving current draw data associated with current draw of the motor measured while the motor transitions the sectional door between the open state and the closed state during a closing cycle or an opening cycle;
receiving input voltage data for supplying the motor;
determining, based on the current draw data or the input voltage data, whether a falling door condition exists; and
initiating a door control action with respect to the sectional door in response to the falling door condition being determined to exist.

21. The system of claim 20, wherein determining whether the falling door condition exists comprises:
comparing the received current draw data to reference current draw data during the opening or closing cycle to determine a current difference between the received current draw data and the reference current draw data; and
determining the sectional door to be in the falling door condition responsive to the current difference being larger than a threshold current difference value.

22. The system of claim 20, wherein determining whether the falling door condition exists comprises:
comparing the input voltage data to a reference input voltage during the opening cycle or the closing cycle to determine a voltage difference between the input voltage data and the reference input voltage data; and
determining the sectional door to be in the falling door condition responsive to the voltage difference being larger than a threshold voltage difference value.

23. The system of claim 20, wherein determining whether the falling door condition exists comprises:
comparing the input voltage data to a reference input voltage prior to the opening cycle or the closing cycle to determine a voltage difference between the input voltage data and the reference input voltage data; and
determining the sectional door to be in the falling door condition responsive to the voltage difference being larger than a threshold voltage difference value.
